(19) United States
(12) Patent Application Publication
(10) Pub. No.: US 2008/0091555 A1
(43) Pub. Date: Apr. 17, 2008

(54) User generated style content

(76) Inventors: Ashley Heather, New York, NY (US); Alberto Escarlate, Westport, CT (US); Matthew Robinson, New York, NY (US); Charles Darling, Houston, TX (US)

Correspondence Address: KENYON & KENYON LLP, ONE BROADWAY, NEW YORK, NY, 10004, US

(21) Appl. No.: 11/580,724

(22) Filed: Oct. 13, 2006

(51) Int. Cl. G06Q 30/00

(52) U.S. Cl. 705/26

(57) ABSTRACT

A system and method for user generated content includes receiving a user-selected data field, which includes reference to a particular item or element to be displayed on a web portal. The system and method associates the data field with an electronic log, such as automatically generating an electronic log entry off of a template to include the received data field. The system and method thereby associates the electronic log with the registered user that provided the data field. The electronic log, which may be referenced by the user, is provided to a central log repository location, such that it is thereupon viewable through the web portal. The system and method associates the content element with a commercial vendor, which thereby allows for the purchase of the content element and subsequently through tracking the purchase element, the registered user may be given credit for any subsequent purchase.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to the electronic processing and display of user generated content in a web based portal and more specifically to the utilization of this user generated content in a peer promotional, electronically commercial or otherwise interactive electronic processing environment.

An emerging growth in online electronic communities is the facilitation of a new breed of electronic content referred to as user generated content. A common software development includes online communities using “wiki” -based technology for content growth. For example, an online encyclopedia presently referred to as “wikipedia”® allows various users to not only create, but update and otherwise moderate a large database of information, in this case an online encyclopedia of information. This information, based on the wiki technology, is entirely user generated.

These user-generated technologies allow for the development of peer-based communities for any number of purposes. Another version of user generated content includes various peer-to-peer or networking sites. By way of example, several currently available networking sites include “Orkut”, “Linkedln” and “MySpace” sites. There are also user-generated content sites that allow for the uploading of user-generated content, where a current example is the YouTube Internet site.

Yet another well-known example of user-generated content is the vast number of weblogs found on the Internet, commonly referred to as “blogs” for short. These blogs provide an online platform for users to compose and post entries on any number of topics only limited by the user's creativity. Many blogs can be found on central blog hosting sites, but the nature of the blog and the user-generated content allows these blogs to be actively maintained and read from any HTTP-enabled software client.

The growth of user-generated content has allowed for the organic growth of online content, but this online content has defined limitations making it a very static form of communication. For example, this content typically includes text itself, maybe some pictures and/or video(s) and links to other user generated content or popular web sites. This one-dimensional information is non-interactive and constrained by the confines of the subsequent processing systems hosting the user generated content. This information is also constrained by the ability to place the user-generated content in designated electronic locations such that they are readily accessible and thereby viewable by other users.

For example, if a user wishes to generate a blog entry about a particular product, the user currently may use a commercially available software application to write the blog entry. The user may then upload a picture of the product, manually construct the blog entry and may even provide a universal resource location (URL) hyperlink to the manufacturer's web site. Aside from the author's sense of accomplishment for generating this content, the content is limited by being one of many million blogs regularly published. Because of the vast number of blogs, this thereby reduces the chance that any more than a few regular visitors or subscribers will even know about this blog entry. Additionally, the user will receive no benefit for describing and in essence providing free advertising for the product and its manufacturer. The blog entry could even include a hyperlink to an online retailer that sells the product, but unless the user themselves negotiates and creates a direct association with the online retailer and follows complicated procedures for coordinating compensation or other types of incentives, the user does not receives any compensation or credit for directing traffic to the particular retailer.

While there are promotional web sites that do receive compensation for referral commercial activity, these sites are not based on user-generated content. A classic example is a banner or other advertising link on a web page, the URL may include an originator identifier to credit the originating web site for directing traffic to the retailer's site. These scenarios also typically include some type of predefined contractual relationship between the various parties.

Current systems provide for a centralized repository for like-minded user-generated content based on the focus of the content, thereby better providing for incoming Internet traffic and subsequent larger volumes of readership. In the current environment of user generated content, there does not exist the ability to generate centrally disposed content regarding a commercial element and receive proper compensation when a reader makes a purchase based on the user generated content.

### BRIEF DESCRIPTION OF THE DRAWINGS

FIG. 1 illustrates a block diagram of one embodiment of a processing system allowing for the generation of user-generated content on a web portal;

FIG. 2 illustrates a block diagram of another embodiment of a system allowing the generation of user-generated content on a web portal;

FIG. 3 illustrates a sample screen shot of one exemplary embodiment of a user-generated style log;

FIG. 4 illustrates another sample screen shot of another exemplary embodiment of the user-generated style log;

FIG. 5 illustrates a flowchart of the steps of one embodiment of a method for generating user generated electronic content on a web portal; and

FIG. 6 illustrates a flowchart of the steps of an embodiment of a method for hosting user-generated style content.

### DETAILED DESCRIPTION

Utilizing user-generated content provides a unique opportunity to quickly populate content on a web portal relative to registered user requests, where the web portal is also commonly referred to a web site accessible by a web address. Through the uploading of content information to the web portal, processing components provide for formatting the information into pre-defined forms or logs that can be used as a basis for generating or adding to a user-generated log. The processing component may further include steps for commercializing the user-generated content by determining commercial vendors available for purchasing the logged item. Through the processing component, the log may include active hyperlinks or other means for allowing visitors to view and subsequently purchase items from the logs. By tracking relationships defined by the log, the user that provided the user-generated content may therefore be eligible to receive credit or other compensation for recommending the element(s) noted in the log.

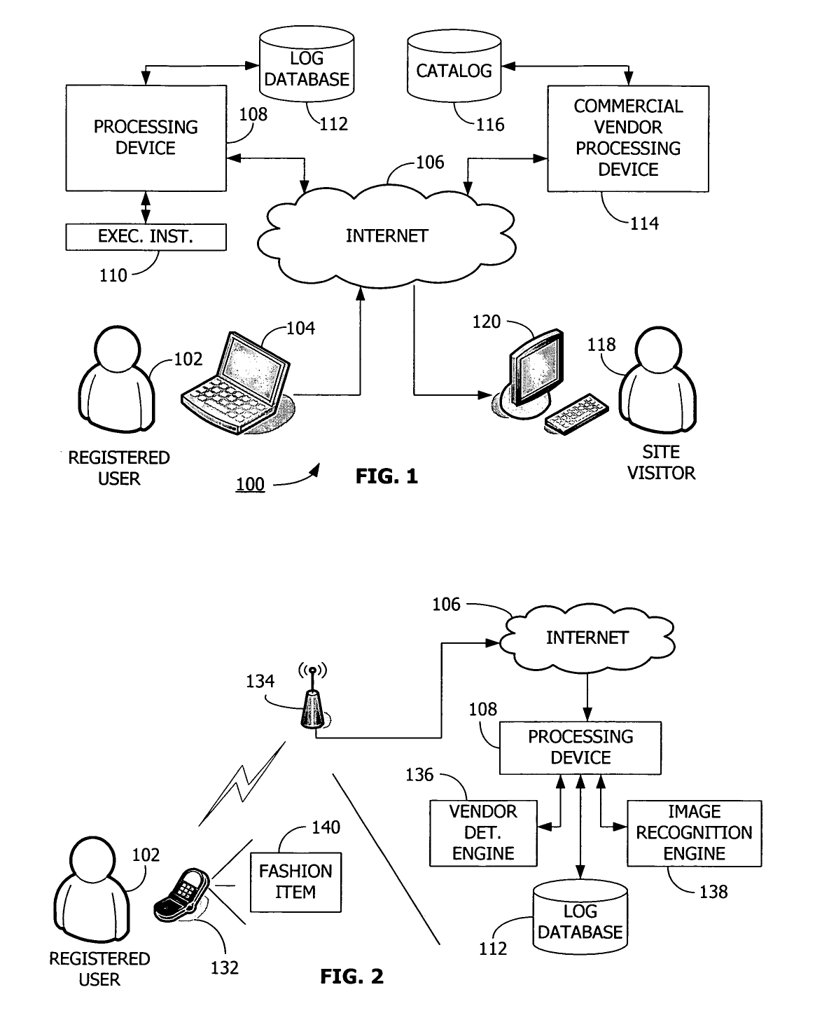

FIG. 1 illustrates a system 100 includes a registered user 102 having a personal computing device 104, Internet 106, a processing device 108, executable instructions 110, a log database 112, a commercial vendor processing device 114, a catalog 116 and a site visitor 118 having a personal computer 120.

Registered users 102, as the term is used herein, refers to users having predefined relationships with the web portal. For example, a registered user 102 may be a person who has filled out a registration form, agreed to terms of use and supplied additional information, such as a user name and other identifying information. The term registered user may also more broadly refer to users having access and the ability to supply and post information, which may include abilities to anonymously post or otherwise modify content.

The registered user 102 differentiates from the visitor 118, where the registered user 102 may also be the visitor 120. The visitor 120 relates to a web portal user who accesses the site to view and otherwise interact with the web portal. For example, a registered user 102 may be considered a visitor 118 when viewing and interacting with the logs of other users. It is also noted that a registered user 102 could additionally be considered a visitor 118 if the registered user commercially interacted with the user's own log, such as purchasing an item or otherwise acquiring credit, as described in further detail below.

The computing device 104 is illustrated as a laptop computer, but it is recognized that this device may be any suitable device capable of communicating with the processing device 108 either through′the Internet 106 or any other suitable communication networks. The web portal provides the capability for user interaction through hosting the web site and executing processing operations thereto, including presenting data to requesting devices accessing the web portal through the Internet. In a typical example, the processing device 108 may generate various mark-up language programming code and other programmable routines and transmit the code and routines to the processing device 104, which uses a browsing application to view the code and routines, hence in essence virtually visiting the web portal, in accordance with known Internet connection and data transmission techniques.

The processing device 108 may be one or more processing elements capable of performing processing operations in response to executable instructions 110. The executable instructions 110 may be stored in one more storage locations and provide for the execution of defined operations, facilitating user-generated content as described in further detail below. The log database 112 may be one or more storage locations, either locally or remotely disposed relative to the processing device 108, capable of storing and providing for subsequent retrieval of various user-generated logs and additional information that may be included in the logs.

The commercial vendor processing device 114 may be similar to the processing device 108 such that the processing device 114 performs executable operations allowing for the conducting of commercial activities, such as for example a web portal for a particular retailer allowing a visitor to shop and subsequently purchase one or more items in an electronically commercial environment. The catalog 116, similar to the log database 112, may be one or more storage devices, whereas the catalog 116 includes product information offered for sale by or through the commercial vendor web portal.

Additionally, the computing device 120 may be any suitable processing device or component allowing the site visitor 118 to access the Internet 106 and subsequently visit or otherwise view the web portal hosting the user-generated logs. The computing device 120 may also visit the commercial web portal made available by the commercial vendor processing device.

In the operation of one embodiment of the apparatus 100 providing for user-generated content through the Internet 106, the registered user 102 may provide an input that includes a user-selected data field. In this embodiment, the user-generated content and subsequent logs relate to topics of style. This input may include, for example, a snapshot of a particular piece of clothing or other style related element, or a video clip including a style related item. The registered user 102 may provide various forms of inputs to the processing device 108, including for example a picture, video sequence, product information, and/or a link to further information, product identification information, such as a UPC or bar code for example, or any other suitable input.

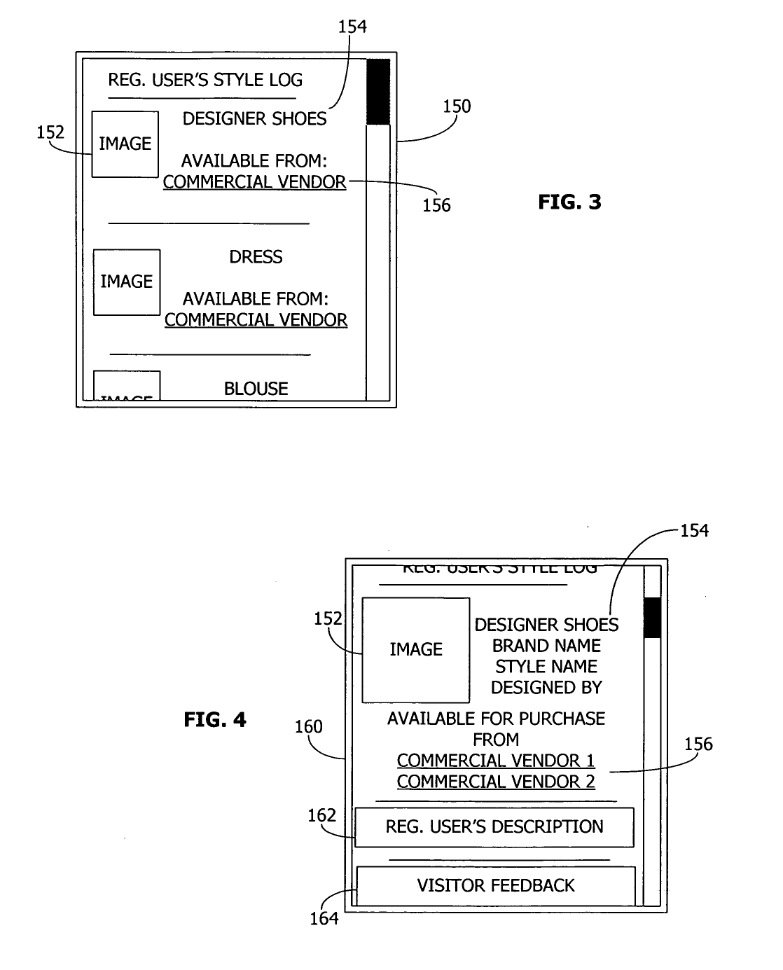

Through the inclusion of registration information, the processing device 108 may thereupon recognize the registered user and the style or style related input. In processing steps based on the executable instructions, the processing device associates the data field with an electronic log, where this may include generating a new log entry or adding to an existing log. This step may be performed in numerous techniques, such as described in the sample screen shots of FIGS. 3 and 4, where one embodiment includes posting the input element and determining related information to be included therewith.

Including this input into the log to create the user-generated content may include additional steps of determining additional information, for example the exemplary embodiment of sending a product identification code may include accessing a product information database that can provide the information to more accurately determine the element for the newest log or log entry. In another embodiment, when a user submits a hyperlink or a web address, a processing step may include accessing the linked content.

After the log is created, the log may then be published or otherwise made publicly available. In one embodiment this may include simply updating an existing log, which may includes attending to really simple syndication (RSS) feed distributions. In addition to the generation of the log, the processing device 108 is further operative to include commercial information, thereby broadening the benefit of the log from merely an informational display to allowing user-interaction and subsequent purchase of listed or displayed elements. The inclusion of commercial information may include a processing component, as described in further detail below, that provides such commercial or vendor web portal information.

Therefore, the visitor 118 through the computing system 120 is capable of visiting the web portal, viewing the registered user's log and learning about the user-selected item. The log content is user-generated. Additionally, the visitor 118 can purchase the user-selected item, whereby active linking or other techniques allow the registered user 102 to receive credit for directing the visitor 118 to the subsequent purchase. Credit may be based on existing defined or otherwise understood relationships between the log hosting web portal or the registered user and the commercial site(s). As discussed in further detail below, other embodiments and processing options of the user-generated log are additionally possible.

FIG. 2 illustrates another embodiment of a system 130 for the creation of user-generated content in an online electronic log. The system 130 includes the registered user 102 having a data capture device 132, a wireless receiver 134, Internet 106, processing device 108, a vendor determination engine 136, the log database 112 and an image recognition engine 138.

The data capture device 132 is illustrated as a camera phone, but may be any suitable device capable of capturing and providing captured information to the processing device 108. Additionally, the data capture device 132 is illustrated as having the ability to wirelessly transmit data to the Internet 106, but similar to the embodiment described above in FIG. 1, this data may also be submitted using a wired connection, such as the data capture device 132 being connected to a computer, such as the computer 104 of FIG. 1.

The wireless receiver device 134 may be any receiver capable of receiving incoming wireless signals and operative to communicate with the Internet 106, such as through an existing telecommunications backbone or suitable system. The vendor determination engine 136 may be a module implemented in hardware, software or a combination thereof capable of determining appropriate vendors or other providers of items documented in user-generated logs. Similarly, the image recognition engine 138 may be implemented in hardware, software or a combination thereof for performing image recognition operations, such as attempting to recognize the various user-submitted items based on submitted images.

In the system 130, a registered user 102 may use the phone 132 to take a snapshot or video clip of a style item, such as for example a shirt or fashion accessory someone is wearing. Through a directed transmission, such as by the phone having web-enabled functionality, the user 102 may then wirelessly upload the image or image(s) of the style item to the Internet 106 through the wireless receiver 134. Using known protocols and routing techniques, the image(s) may be provided to the processing device 108 as the device processes data relating to the associate web portal. In another embodiment, the phone 132, or any other suitable image capturing device, may be able to take a picture or otherwise read a barcode or other identifier and thereby use this barcode or other identification to thereby identify the style item. In another embodiment, an RFID tag reader or other type of wireless signal may be received, such as RFID tags inserted in clothing and readable by a mobile phone 132, where the recognition of the RFID signal may be used as input for generating a subsequent electronic log described the style item.

In the embodiment of FIG. 2, the processing device may submit the image(s) to the image recognition engine 138. The engine 138 may perform various processing operations to attempt to automatically determine the style item 140 in the image(s). It is recognized that various factors can make effective automated recognition difficult, such as similarities between different style items and quality factors in the submitted images, for example. Therefore, the image recognition engine 138 may also include generating a user-recognition functionality for the web portal, such as generating a log or adding an interactive component to a log inquiring for user feedback as to what a particular item is.

By way of example, suppose the user 102 snaps a picture of a pair of shoes but is not aware of the make or model. The image recognition engine 138 may thereupon generate a feedback component asking visitors to input the information as to the specifics of the particular pair of shoes. This further advances the user-generated content of the web portal by allowing visitors to augment the collective information on the portal through existing interactive techniques.

If specifics of an item are known, or if approximations are known, the processing device 108 may utilize the vendor determination engine to find corresponding commercial sites or vendors offering the particular item or similar item for sale. For example, if a particular item cannot be accurately determined, a similar-looking item may be selected for the log. The vendor determination engine may use the specific information of the item included in the log to determine proper vendors. In one embodiment, specifics may include a particular designer label and a style name. From this, search engines may scan various commercial sites to determine if the item is available for purchase. When found, the engine 136 may add this information to the log, which is stored in the log database 112, so that as described above with respect to FIG. 1, when the visitor 118 views the log, the visitor 118 may readily purchase the style item 140 from a commercial vendor 114.

FIG. 3 illustrates a sample screen shot 150 of a registered user's style log including various log entries. The log, as typically viewed through a web browser application, may provide an image display 152 with corresponding text 154. Additionally, where available, the log may also contain the active link 156 to a commercial vendor so that a visitor may activate the hyperlink to be directed to the commercial vendor for subsequently purchasing the style item.

The sample user-generated log of FIG. 3 is a very basic example of a screen shot and it is recognized that many additional visual and processing components may be included. For example, the screen shot 150 may represent a log front page where active links may provide for a full page or full screen viewing of the designated entries.

For example, FIG. 4 illustrates a sample screen shot 160 of an individual log entry, where this screen shot may allow for further levels of detailed information. As this content is user-generated, a portal may allow the registered user to modify or otherwise edit the log entries, such as using known interactive computing and processing techniques.

In the sample screen shot 160 for the individual log entry, the image 152 is prominently displayed, where the image or images in video sequence may be the image(s) acquired by the user, such as the camera phone of FIG. 2, or may be a substituted image of the style item, such as an image provided by the manufacturer or a vendor, or even possibly a picture of a famous person wearing or otherwise modeling the style item. It is further recognized that a video may be an interactive video sequence, such as the interactive video sequence described in further detail in co-pending and commonly-assigned patent application Ser. No. ______ entitled “Method and System for Providing Interactive Video.”

The log may include additional information 154 about the style item, such as for example the brand name of the item and who designed the item. The item may also be available for purchase from one or more commercial vendors, such that the hyperlinks 156 may provide for various commercial vendors. In one embodiment, the hyperlinks may include header tags or other identifier information to automatically notify the commercial vendor sites that a visitor has been directed to the commercial site from the log, therefore the registered user may be given some form of credit if the visitor purchases the item. In another embodiment, where a commercial vendor is not available, the hyperlink may be to instructions or other information such that a visitor may acquire the style item by other means, such as the link causing the generation of a printable coupon that can be taken to a physical store for example.

The log in the screen shot 160 of FIG. 4 may include additional features, such as a registered user's description field. The registered user may wish to provide a personalized description or account of the product, such as a specific recommendation about the product. Another possible field in the log may be a visitor feedback field 164 that allows visitors to input their own information, such as their recommendations about the product for example. It is recognized that many additional features and components may be included in the style log allowing for the dissemination of user-generated style information using the processing device 108 of FIG. 1 accessible across the Internet 106.

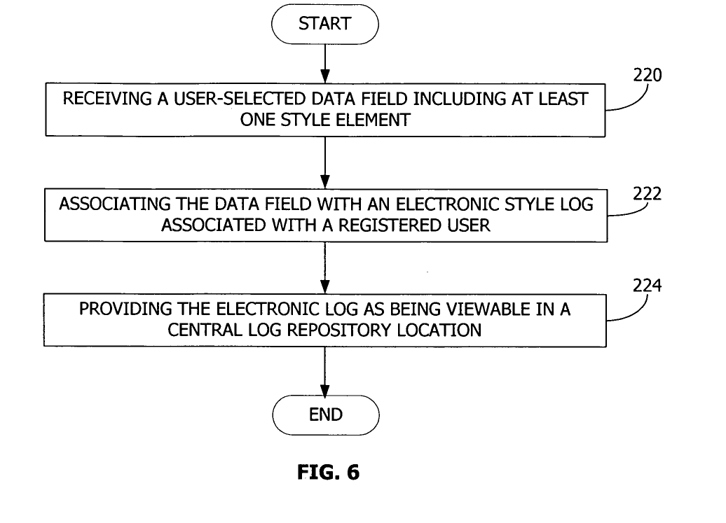

FIG. 6 illustrates a flowchart of the steps of one embodiment of a method for user-generated electronic content. The method begins, step 200, by receiving a user-selected data field. The step may be performed by the processing device 108 of FIG. 1 receiving an input signal having a user-selected data field contained therein, where the data field relates to an element to be included in a log entry. In one embodiment described above, the user-selected data field may be a photograph of a particular style item. In various other embodiments, the data field may be other types of input data, such as a bar code or other identification field, such as a data field received from a RFID tag or other type of wireless transmission device, or in another exemplary embodiment the input field may be a description of the particular item or a link to an image or description of the image.

Regardless of the specific formatting of the user-selected data field, the next step, step 202, is associating the data field with an electronic log. This step may be performed by the processing device 108 generating a template including the data field, such as for example the template being encoded in a mark-up language or other language viewable or otherwise accessible by a browsing application.

In the next step, step 204, the method includes associating the electronic log with at least one registered user. One embodiment includes user identification information being included when the user-selected data field is received. The user identification may include login information to verify identity or may be more generalized information for the initial generation of the log entry and allow for further user-refinements at a later time.

The next step, step 206, is providing the electronic log as being viewable in a central log repository location. In the system of FIG. 1, this may include storing the electronic log in the log database 112, where the database 112 is accessible using a browser or other suitable application through a web portal, which may host the user-generated logs. The processing device 108 may provide the logs as being viewable through standard mark-up language or other browser applications through users accessing and requesting such log information, such as through using various web address or HTrP-enabled identifiers.

In this embodiment, the next step, step 208, may include associating a content element of the user-selected data field with a commercial vendor for allowing the purchase of the content element. One embodiment may include the vendor determination engine 136 automatically determining one or more vendors capable of selling the particular item, wherein the vendor determination engine 136 may also provide for the determination of vendor sites that operate to give credit or other incentives to users who place and essentially promote the underlying item. It is also recognized that this step may be performed by other means, such as the manual entrance of vendor information, such as active linking or providing vendor information for the automated insertion of such information into the user's log.

The next step, step 210, is tracking a purchase of the content element based on the electronic log, such that the registered user is given a credit for the purchase. There are various forms of credit that may be given to the registered user. For example, one type of credit is a financial credit, such as either actual money or usable financial credit that can be redeemed at a particular location. Other types of credit may include points redeemable for various items or even possible virtual credits usable in a virtual environment. It is recognized that other exemplary types of credit may be utilized to thereby reward the registered user for the promotion and facilitation for the subsequent purchase of the logged item. Thereupon, in this embodiment, the method is complete.

FIG. 6 illustrates a flowchart of the steps of a method for hosting user-generated style content. The method may be performed, in one embodiment, by the processing device 108 associated with one or more web portals accessible through one or more web addresses or other address identifiers. In this embodiment, the first step, step 220, is receiving a user-selected data field including at least one style element. The user-selected data field may be in any suitable format usable by the processing device to determine the referenced style element, such as for example, but not limited to, a photograph, an identification field or product information.

The next step, step 222, is associating the data field with an electronic style log associated with a registered user. Based on user information, the style log may be included within an existing log or made as a new log entry accessible or otherwise reference to the registered user's account or existing log.

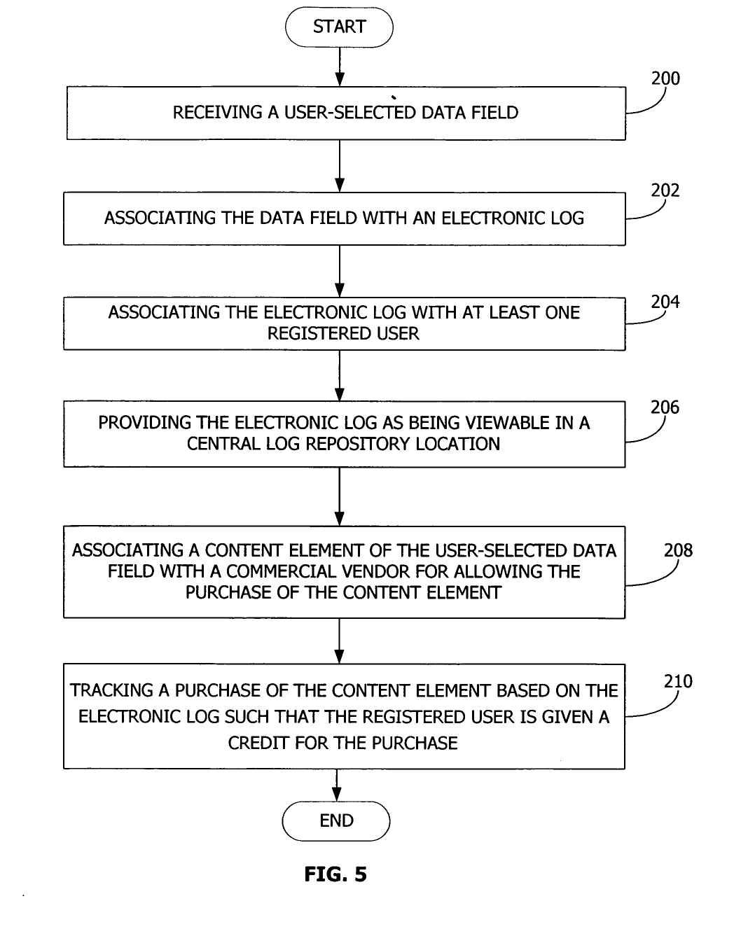

The next step, step 224, is providing the electronic log as being viewable in a central log repository location. This step may be similar to step 206 in the method described above in the flowchart of FIG. 5. Thereupon, in this embodiment the method is complete, providing user-generated content for a style log.

Through the operations of the method and apparatus, user generated content is provided such that registered users can upload various elements to style logs. The style logs, displaying the elements and active links to commercial vendors, allows for the dual benefit of directing a visitor to a place for subsequent purchase of the displayed item and allowing the user to receive compensation or some other form of credit for promoting the item and furthering the chance of a potential sale. The user-generated component allows for the organic growth of web based content relative to the purpose of the web portal, while also providing direct benefits to visitors through existing promotional web pages and ready access to commercial outlets, electronic or otherwise, for readily purchasing such promoted items.

Although the preceding text sets forth a detailed description of various embodiments, it should be understood that the legal scope of the invention is defined by the words of the claims set forth below. The detailed description provided herein is to be construed as exemplary only and does not describe every possible embodiment of the invention, because describing every possible embodiment would be impractical, if not impossible. It should also be noted that the sequence or arrangement of the particular steps shown in various figures accompanying the description of the embodiments of the current invention is not limiting, and it is understood that rearranging these described steps is within the scope of the contemplated invention. Numerous alternative embodiments could also be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principles disclosed and claimed herein.

What is claimed is:

1. A user-generated electronic log generated by executable instructions processed on an electronic processing device, the log generated by instructions comprising:
receiving a user-selected data field;
associating the data field with an electronic log;
associating the electronic log with at least one registered user;
providing the electronic log as being viewable in a central log repository location;
associating a content element of the user-selected data field with a commercial vendor for allowing the purchase of the content element; and
tracking a purchase of the content element based on the electronic log such that the registered user is given a credit for the purchase.

2. The user-generated electronic log of claim 1 wherein the processing device, in executing the step of receiving the user-selected data field is further operative to receive the data field in the form of at least one of: a picture and a video sequence, and performing an image recognition operation on the at least one: picture and video sequence.

3. The user-generated log of claim 2 wherein the at least one of: picture and video sequence, is received from a mobile device having a camera included therein.

4. The user-generated log of claim 1 wherein the processing device, in executing the step of receiving the user-selected data field is further operative to receive the data field from a wireless identification tag.

5. The user-generated log of claim 1 wherein the user-selected data field includes information associated with a bar code identifying the content element.

6. The user-generated log of claim 1 wherein the processing device, in executing the step of receiving the user-selected data field is further operative to receive the data field as an active link from an electronic commerce web portal.

7. The user-generated log of claim 1 wherein the content of the user-selected data field is related to style.

8. The user-generated log of claim 1 wherein the electronic log is electronically available from a centralized web portal.

9. The user-generated log of claim 1, the processing device further operative to determine at least one commercial vendor capable of facilitating the purchase of the content element.

10. The user-generated log of claim 1, the processing device further operative to receive a user-generated description associated with at least one of the content element and the user-selected data field and display the user-generated description in the electronic log.

11. A method for user generated electronic content, the method comprising:
receiving a user-selected data field;
associating the data field with an electronic log;
associating the electronic log with at least one registered user;
providing the electronic log as being viewable in a central log repository location;
associating a content element of the user-selected data field with a commercial vendor for allowing the purchase of the content element; and
tracking a purchase of the content element based on the electronic log such that the registered user is given a credit for the purchase.

12. The method of claim 11 further comprising:
receiving the data field in the form of at least one of: a picture and a video sequence; and
performing an image recognition operation on the received at least one: picture and video sequence.

13. The method of claim 12 wherein the picture is received from a mobile device having a camera included therein.

14. The method of claim 11 further comprising:
receiving the data field from a wireless identification tag.

15. The method of claim 11 wherein the user-selected data field includes information associated with a bar code identifying the content element.

16. The method of claim 11 further comprising:
receiving the data field as an active link from an electronic commerce web portal.

17. The method of claim 11 wherein the user-generated content relates to style.

18. The method of claim 11 wherein the electronic log is electronically available from a centralized web portal.

19. The method of claim 11 further comprising:
electronically determining at least one commercial vendor capable of facilitating the purchase of the content element.

20. The method of claim 11 further comprising:
receiving a user-generated description associated with at least one of the content element and the user-selected data field; and
displaying the user-generated description in the electronic log.

21. A method for hosting user-generated style content, the method comprising:
receiving a user-selected data field including at least one style element;
associating the data field with an electronic style log associated with a registered user; and
providing the electronic log as being viewable in a central log repository location.

22. The method of claim 21 further comprising:
receiving a user-generated description associated with at least one of the content element and the user-selected data field; and
displaying the user-generated description in the electronic log.

23. The method of claim 21 further comprising:
receiving the data field in the form of at least one of: a picture and a video sequence; and
performing an image recognition operation on the received at least one: picture and video sequence.

24. The method of claim 21 wherein the picture is received from a mobile device having a camera included therein.

25. The method of claim 21 wherein the user-selected data field includes information associated with a bar code identifying the content element.

26. The method of claim 21 further comprising:
receiving the data field from a wireless identification tag.

27. The method of claim 21 further comprising:
receiving the data field as an active link from an electronic commerce web portal.

28. The method of claim 21 further comprising:
associating a content element of the user-selected data field with a commercial vendor for allowing the purchase of the content element; and
tracking a purchase of the content element based on the electronic log such that the registered user is given a credit for the purchase.

29. The method of claim 28 further comprising:
electronically determining at least one commercial vendor capable of facilitating the purchase of the content element.
